(19) United States
(12) Patent Application Publication
(10) Pub. No.: US 2015/0081391 A1
(43) Pub. Date: Mar. 19, 2015

(54) ANALYTICS-DRIVEN PRODUCT RECOMMENDATION FOR FINANCIAL SERVICES

(71) Applicant: International Business Machines Corporation, Armonk, NY (US)

(72) Inventors: JoAnn P. Brereton, Hawthorne, NY (US); Arun Hampapur, Norwalk, CT (US); Hongfei Li, Briarcliff Manor, NY (US); Robin Lougee, Yorktown Heights, NY (US); Buyue Qian, Sacramento, CA (US)

(73) Assignee: International Business Machines Corporation, Armonk, NY (US)

(21) Appl. No.: 14/027,469

(22) Filed: Sep. 16, 2013

(51) Int. Cl. G06Q 30/02

(52) U.S. Cl. CPC G06Q 30/0201
USPC 705/7.34; 705/7.33

(57) ABSTRACT

An aspect of product recommendation processes includes classifying customers into groups based on commonly shared, predefined characteristics and common financial transaction activities conducted. For each service offered, the product recommendation processes include estimating a cost of recommendation of the service; and estimating, for each of the customers in a group, a transaction risk of providing the service. For each group, the product recommendation processes include: identifying services available that are not rendered; estimating, based on economic health data associated with the corresponding customers, a probability of an acceptance by the corresponding customers of an offer for available services; estimating a profit based on historical profit data acquired from results of rendering the service to the customers of the group; and selecting a subset of the available services to offer the customers as a function of the cost of recommendation, the transaction risk, the probability of acceptance, and estimated profit.

### BACKGROUND

The present invention relates to financial services and, more specifically, to analytics-driven product recommendation for financial services.

Financial service providers are seeking new ways to grow their businesses in order to stay competitive. Oftentimes, there are customers of the providers who may be eligible for certain products and services that the providers offer (e.g., extended credit lines or transactional daily limits), however the providers typically lack the visibility into the customer's overall financial picture to calculate the risks involved in making the decision to provide the products or services.

Many service providers attempt to resolve these challenges using an intensive manual process that can be quite costly.

### SUMMARY

According to one embodiment of the present invention, a method is provided. The method includes classifying, by a computer processor, customers of an entity into groups based on commonly shared, predefined characteristics and common financial transaction activities conducted among the customers. For each service of the services offered by the entity, the method includes: estimating a cost of recommendation of the service; and estimating, for each of the customers in a corresponding group, a transaction risk of providing the service. The transaction risk is estimated based on the common financial transaction activities. For each group in the groups of customers, the method includes: identifying services available that are not rendered for corresponding customers; estimating, based on economic health data associated with the corresponding customers, a probability of an acceptance by the corresponding customers of an offer for available services; estimating a profit based on historical profit data acquired from results of rendering the service to the corresponding customers of the respective group, the profit data derived from the common financial transaction activities; and selecting, via the computer processor, at least a subset of the available services to offer the corresponding customers as a function of the cost of recommendation, the transaction risk, the probability of acceptance, and estimated profit.

According to another embodiment of the present invention, a system is provided. The system includes a computer processing system and logic executable by the computer processing system. The logic is configured to implement a method. The method includes classifying customers of an entity into groups based on commonly shared, predefined characteristics and common financial transaction activities conducted among the customers. For each service of the services offered by the entity, the method includes: estimating a cost of recommendation of the service; and estimating, for each of the customers in a corresponding group, a transaction risk of providing the service. The transaction risk is estimated based on the common financial transaction activities. For each group in the groups of customers, the method includes: identifying services available that are not rendered for corresponding customers; estimating, based on economic health data associated with the corresponding customers, a probability of an acceptance by the corresponding customers of an offer for available services; estimating a profit based on historical profit data acquired from results of rendering the service to the corresponding customers of the respective group, the profit data derived from the common financial transaction activities; and selecting at least a subset of the available services to offer the corresponding customers as a function of the cost of recommendation, the transaction risk, the probability of acceptance, and estimated profit.

According to a further embodiment of the present invention, a computer program product is provided. The computer program product includes a storage medium embodied with machine-readable program instructions, which when executed by a computer causes the computer to implement a method. The method includes classifying customers of an entity into groups based on commonly shared, predefined characteristics and common financial transaction activities conducted among the customers. For each service of the services offered by the entity, the method includes: estimating a cost of recommendation of the service; and estimating, for each of the customers in a corresponding group, a transaction risk of providing the service. The transaction risk is estimated based on the common financial transaction activities. For each group in the groups of customers, the method includes: identifying services available that are not rendered for corresponding customers; estimating, based on economic health data associated with the corresponding customers, a probability of an acceptance by the corresponding customers of an offer for available services; estimating a profit based on historical profit data acquired from results of rendering the service to the corresponding customers of the respective group, the profit data derived from the common financial transaction activities; and selecting at least a subset of the available services to offer the corresponding customers as a function of the cost of recommendation, the transaction risk, the probability of acceptance, and estimated profit.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which product recommendation processes may be implemented according to an embodiment of the present invention;

FIG. 2 depicts a flow diagram describing a process for implementing product recommendations according to an embodiment of the present invention; and

FIG. 3 depicts a data flow diagram for implementing product recommendations according to an embodiment of the present invention.

### DETAILED DESCRIPTION

Exemplary embodiments provide product recommendation processes for offering financial products and services (collectively referred to herein as “services”). The products and services may include, e.g., checking, savings, and credit accounts; loans, investments, and mortgage products, to name a few. The embodiments include segmenting a customer base into groups of customers, whereby each group consists of customers having the same or similar predefined characteristics. The embodiments include evaluating costs of service recommendations and risks based on historical data collected for these services, as well as evaluating probabilities of customers accepting offers for the services and associated anticipated profits. The risks and profit data are analyzed and a recommendation indicator value is determined that represents the amount of risk and reward anticipated for a particular customer and service. Based on the indicator value, the embodiments determine whether to offer the service to the customer. These and other features of the product recommendation processes will now be described.

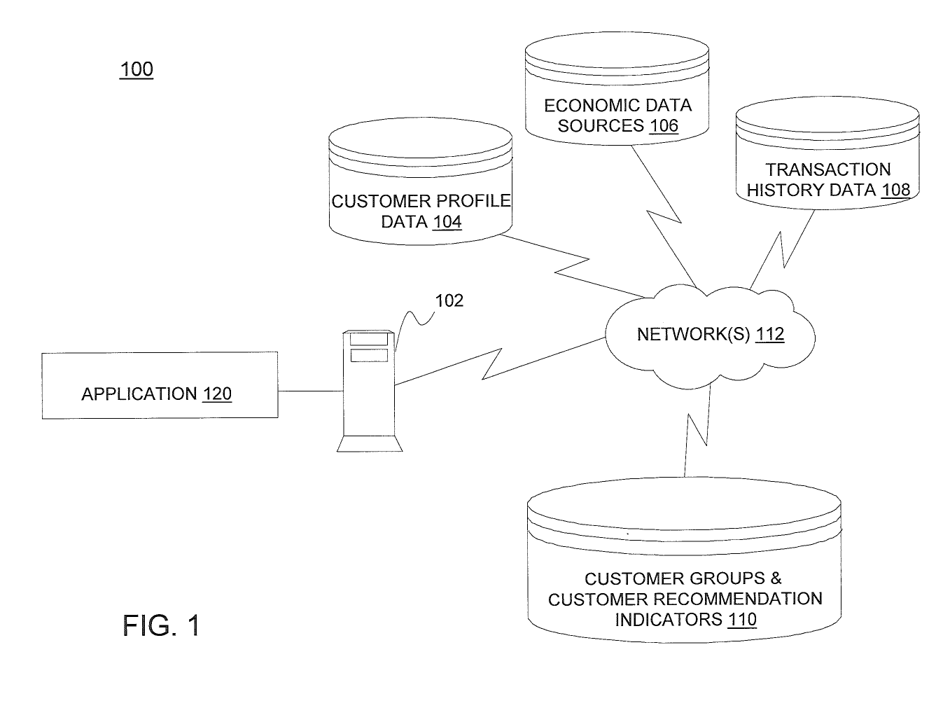

Turning now to FIG. 1, a system 100 upon which the product recommendation processes may be implemented will now be described in an exemplary embodiment. The system 100 of FIG. 1 includes a host system 102 in communication with various data sources 104-110 over one or more networks 112.

The host system 102 may be implemented as a high-speed computer processing device (e.g., a mainframe computer) that is capable of handling a large volume of data received from the data sources 104-110. The host system 102 may be implemented by any entity or enterprise that collects and processes a large amount of data from a multitude of data sources (e.g., data sources 104-110) to manage, or may be offered as a service to such entity by, e.g., an application service provider (ASP). In an embodiment, the host system 102 is implemented by a financial institution that offers various financial-related services to its customers, such as credit account offerings and savings account offerings, investment products, and mortgage products, as well as various differing terms, such as transaction risk daily limits, interest rates, and penalties.

The data sources 104-110 are implemented as data storage devices that are configured to receive and store information for access by computer systems, such as the host system 102. In FIG. 1, these data sources 104-110 are shown as individual data storage devices; however, it will be understood that fewer or greater numbers of storage devices may be employed (e.g., data stored in two or more data sources may be integrated into a single storage device) in realizing the advantages of the embodiments described herein. In addition, while shown in FIG. 1 as being coupled to the host system 102 through networks 112, it will be understood that one or more of the data sources 104-110 may be directly in communication with the host system 102 (e.g., via cabling). Alternatively, one or more of the data sources 104-110 may be logically addressable by the host system 102, e.g., as a consolidated data source over one or more of the networks 112.

In particular, the data sources include a storage device 104 that stores customer profile data, a storage device 106 that stores economic and/or market data, a storage device 108 that stores transaction history data, and a storage device 110 that stores customer groups and recommendation indicator values.

Customer profile data may include information derived from customer accounts stored and managed by the host system 102. For example, customer profile data may include customer type (e.g., business, personal consumer, for-profit, non-profit, charitable, etc.), customer geographic location(s), number of employees, annual revenue, industry of customer business (e.g., manufacturing, retail, health care, insurance, etc.), length of employment, assets owned, and customer age. Customer profile data may be used to determine similarities among various customers of the entity associated with the host system 102. The customer profile data may be used to define characteristics as a foundation to group customers that share similar traits. For example, one characteristic may be the size of the customer in terms of the number of employees and/or the annual revenue generated by the customer. Another characteristic may be type of business the customer is engaged in. The characteristics may be customized by an administrator of the customer selection processes, if desired.

Economic and market data include economic health of the particular customer, the economic health of the region in which the customer operates, the economic health of the industry in which the customer operates, and/or the current health of the national or global market as a whole. Economic health data may be obtained for a particular customer in part, e.g., from an annual financial report published by the customer or credit scores obtained from a credit report. Economic health information about a region, industry, etc. of the market may be obtained, e.g., from the stock market, current interest rates, industry news reports, etc. The economic health of a particular customer, region of the customer, and industry of the customer may be used, similar to the customer profile data, to group customers that share similar economic health traits. The health of the market as a whole can also be used in implementing the product recommendation processes described herein. For example, in a healthy market, additional services (or services having more customer-favored terms) may be offered to more of the customers of the enterprise, as compared to what may be offered in a lean market.

Transaction history data includes historical information about the transactions conducted between the customer and the entity and/or other enterprises. For example, transaction history data may include frequency of transactions, a frequency and dates of transactions involving a customer's daily limits (cash or credit), any defaults that may have occurred and the dates of the defaults, and average dollar amount of transactions over a period of time. Transactions may also include investment activity and loan activity. The transactions may relate to financial accounts associated with checking, savings, money market, CDs, mortgages, asset acquisition and sale, etc., and may include deposits, withdrawals, credit purchases, cash purchases, loans, and investments.

Customer groups and recommendation indicator values include information derived from processing the customer profile data, economic health data, and transaction history data. The customer groups refer to the classification or segmentation of the customers based on the above-referenced characteristics and information. For example, one group may include all manufacturing-based customers with a size of 500 or more employees. Groups may be further drilled down more granularly, e.g., a group consisting of all manufacturing-based customers with a size of 50-150 employees and having U.S. facilities in the Northeast. The recommendation indicator values are derived from analyses of the costs of recommending a service, expected risks of providing a service, a probability of acceptance of the services by customers, and expected profits from implementing the services once offered to the customers.

Turning back to FIG. 1, the networks 112 may include any type of networks, such as local area networks, wide area networks, virtual private networks, and the Internet. In addition, the networks 112 may be configured to support wireless communications, e.g., via radio frequency (RF) communications, cellular networks, satellite networks, and global positioning (GPS) systems.

The host system 102 executes an application 120 for implementing the exemplary product recommendation processes, as described herein.

As indicated above, in an embodiment, the product recommendation processes (e.g., via the application 120) may also include a user interface component for enabling authorized users to customize customer profile characteristics, business rules and/or threshold values used in the product recommendation processes described herein.

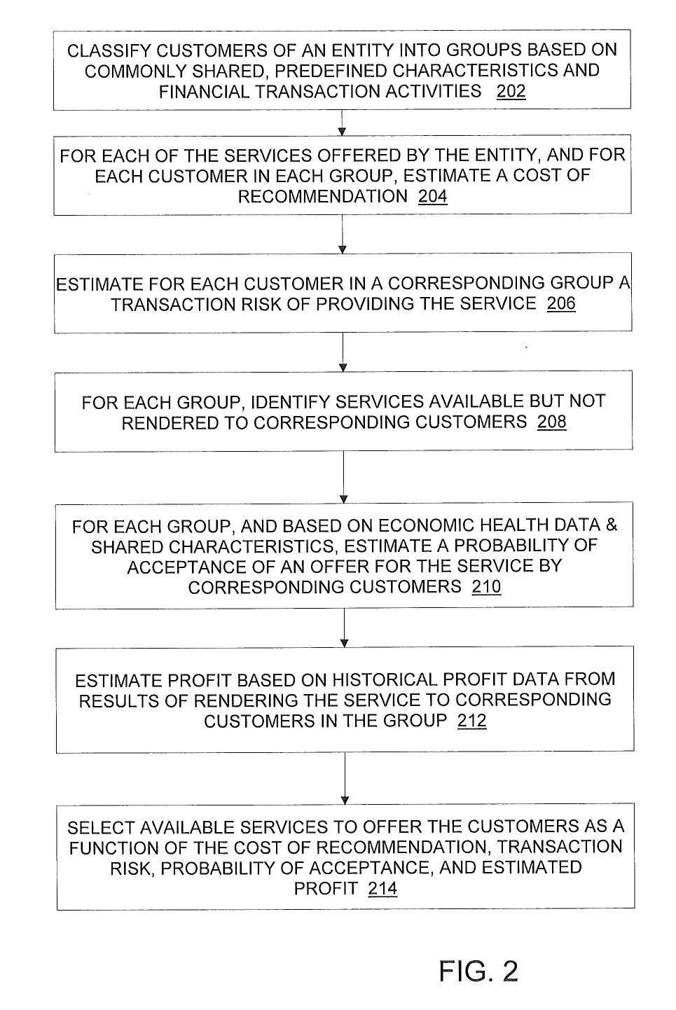

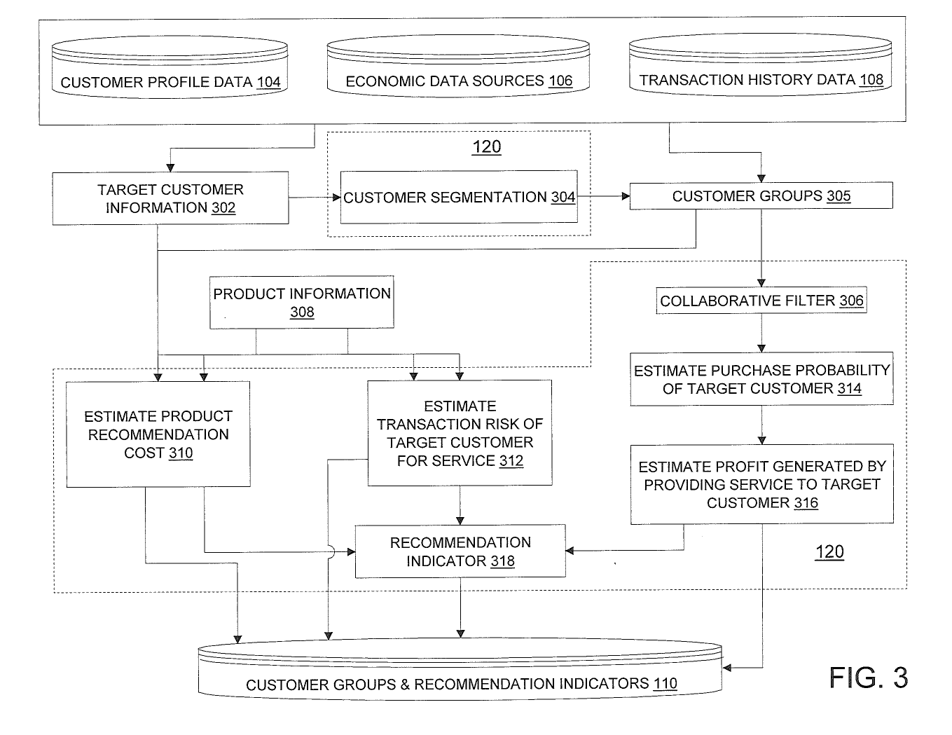

Turning now to FIGS. 2 and 3, a flow diagram and data flow diagram describing a process for implementing product recommendations will now be described in an exemplary embodiment.

At step 202, customers that have an established history of business interactions with the entity or financial enterprise of the host system 102 are classified into groups via the application 120 based on commonly-shared, predefined characteristics from collected customer profile data (from storage device 104). In addition to the customer profile data, the application 120 factors in the economic health of the customer, region in which the customer is located, industry in which the customer works, or the economic health of the market itself (from storage device 106). Further, the application 120 factors in transaction history data in grouping the customers (from storage device 108). By way of example, economic health data may include a customer account balance, an available credit balance, customer ownership of assets, and length of employment, to name a few.

Grouping the customers by predefined characteristics can provide advantages to the enterprise of host system 102, particularly if the entity services a multitude of customers. For example, a large financial banking enterprise having a million or more customers would find it difficult to identify which customers to offer a given service. In the embodiments described herein, the product recommendation processes enable the enterprise to group like or similar customers into groups to render them more manageable in assessing service offerings. Thus, as shown in FIG. 3, the application 120 receives customer profile data, economic data, and transaction data for its customers, which is collectively depicted as target customer information 302. The application 120 processes 304 the target customer information 302 to produce the customer groups 305.

Turning back to FIG. 2, the application performs steps 204 and 206 for each service offered by the entity. In step 204, the application 120 estimates a cost of recommending the service to its customers. The cost may include advertising expenses and/or gifts or other value items to incent the customer to accept an offer for the service. Advertising expenses may include human and electronic resources used to prepare and send the offer to the customer base, such as bulk mailings, electronic advertisements, telemarketing calls, billboards, etc. Gifts are often offered to motivate customers to accept an offer for a service. For example, a bank may offer a $100 deposit to customers who open an account with the bank. Also, a bank may reward a customer with a gift when the customer successfully persuades a family member or friend to open an account or to purchase a financial product. These costs are non-limiting examples of the costs that may be incurred for recommending a service.

Another cost of a service is the risk of loss based on certain circumstances, such as customer default on a loan or credit account, non-use of a financial product (e.g., an open but unused account), unexpected market fluctuations, etc. Thus, in step 206, the application 120 estimates a transaction risk for the customer with respect to a particular service, which is based on known results of offering the service to similar customers in the group. For example, a credit line account of $50,000 may be considered a high risk for a customer of one group (where the customers of the group generally demonstrate a greater incidence of default for similar accounts), and an acceptable risk for a customer of another group (in which the customers of that group generally demonstrate a low incidence of default for similar accounts). Thus, using the transaction history data of customers in the group shared by the customer under evaluation, the application 120 determines an expectation of the risk involved. Implementing high risk services are likely to result in greater losses for the entity. Thus, the application 120 may collectively evaluate the transaction risk (e.g., determine an average) across all customers in the group, as well as for each of the groups.

In an embodiment, the application 120 analyzes the risk relationships between the customers for each group and the service offered in view of the corresponding transaction histories. For example, through the analysis, it is determined that 44 percent of customers in a first group have never been in a default status for a particular service provided to the customers. Further, it is determined that another 38 percent have been in default once over the life of the service provided. Based on target risk percentages or range values adopted by the enterprise, these risks may have a positive or negative effect on the ultimate recommendation decision, as described further herein.

As shown in FIG. 3, the target customer information 302 is evaluated 304 by the application 120 in view of product information 308 and customer groups 305 to estimate 310 product recommendation costs and estimate transaction risks 312.

Turning back to FIG. 2, steps 208-214 are implemented for each group in the set of customer groups 305. At step 208, the application 120 identifies services available (i.e., offered by the entity) but not rendered to the customers in the group. In an embodiment, the application 120 filters each of the customers' profile data in the group according to the services provided and determines which services are not currently implemented for respective customers. A list of customers and their services may be generated and compared against a master list of services to derive this information.

In FIG. 3, the application 120 filters 306 the customers in the group according to services provided. This may yield a list of customers for a group and their associated services, which list may be compared with the master list of available services to determine which services are available but not rendered to the customers.

At step 210, the application 120 considers the economic health data in determining the likelihood or probability that the customers in the group will accept the service if offered by the entity. Factors used in this determination may include, e.g., a customer's account balance, an available credit, ownership of asserts, length of employment, etc. As can be seen, these factors point to a likelihood that the customer is financially capable of successfully using the service. In another example, a lack of ownership in an asset (home or car), or a length of time an asset has been held, can be useful in determining whether the customer is more likely to accept an offer, e.g., of a car loan or mortgage.

Determining the probability of acceptance is a useful step in the process as it allows the entity to save on the costs otherwise associated with advertising (product recommendation) to the customer. In addition, the probability of acceptance across a number of customers enables the entity to better estimate resulting profits from customers who accept the service.

At step 212, the application 120 estimates a profit expected from offering the service to the customers in the group. The application 120 evaluates profits earned from customers in the group shared by the customer under evaluation based on the historical transaction activities. It is expected that the anticipated profit for this customer and service will be similar to the profits received from other similarly situated customers. The application 120 may collectively evaluate (e.g., determine an average) the anticipated profit across all customers in the group, as well as for each of the groups.

At step 214, the application 120 selects available services to offer the customers in the group as a function of the cost of recommendation (step 204), the transaction risk (step 206), the probability of acceptance (step 210), and the expected profit (212). For example, if the cost of recommendation is high but the probability of acceptance is low, there is no need to advertise or offer this service to the customer. If the cost of recommendation and the probability of acceptance are high, and the profit outweighs the risk, the application 120 may determine that the customer is a positive candidate to offer the service, despite the fact that the cost of recommendation is high.

The selection determination may be implemented in various ways. In an embodiment, the application 120 calculates a recommendation indicator value for each of the available services based on the cost of recommendation, the transaction risk, the probability of acceptance, and the estimated profit. The application 120 may use business rules that apply a value that defines the combined cost of recommendation, transaction risk, probability of acceptance and estimated profit. The business rules may be configured (and modified) to define ranges or limits of the amount or extent of risk and recommendation costs that are balanced by the likelihood of acceptance and desired profit margin. In an embodiment, the business rules may be configured such that if the product recommendation value meets or exceeds a threshold value defined, a respective customer who meets this criterion may be offered the corresponding service. Alternatively, when the recommendation value does not meet the threshold value, the service may not be offered to the customer.

As shown in FIG. 3, the application 120 receives results from the filtering 306 and uses this information to estimate the probability of purchase 314 and the anticipated profit 316. The product recommendation cost (from 310), transaction risk (from 312), purchase probability (from 314), and anticipated profit (from 316) are collectively evaluated to derive the recommendation indicator value 318 used in determining which services it will and will not offer its customers.

The following equation (and related description) may be used in calculating the recommendation indicator and resulting product recommendation described herein:

Cᵢⱼ - - - the cost of recommending product j to customer i.

Rᵢⱼ - - - the estimated amount of financial risk of customer i using product j.

Lᵢⱼ - - - the estimated probability of customer i purchasing product j.

Pᵢⱼ - - - the estimated profit of customer i using product j.

Iᵢⱼ - - - recommendation indicator.

Assume there are n potential customers and m products, the problem is formulated as an unconstrained optimization:

$$arg min {\sum }_{i = 1}^{n} {\sum }_{j = 1}^{m} ( {I}_{ij} {L}_{ij} {R}_{ij} + λ {I}_{ij} {C}_{ij} - γ {I}_{ij} {L}_{ij} {P}_{ij} )$$

\lambda and \gamma are the tuning parameters that control the importance or weight of cost and profit. Thus, the product recommendation processes leverage between maximizing the profit, minimizing the risk, and minimizing the recommendation costs.

Technical effects include product recommendations customized for target customer groups with regard to financial products and services. The products and services may include, e.g., checking, savings, and credit accounts; loans, investments, and mortgage products, to name a few. A customer base is segmented into groups of customers, whereby each group consists of customers having the same or similar predefined characteristics, costs of service recommendations and risk are evaluated based on historical data collected for these services, and probabilities of customers accepting offers for the services and associated anticipated profits are evaluated. The risks and profit data are analyzed and a recommendation indicator value is determined that represents the amount of risk and reward anticipated for a particular customer and service. Based on the indicator value, the embodiments determine whether to offer the service to the customer.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A method, comprising:
classifying, by a computer processor, customers of an entity into groups based on commonly shared, predefined characteristics and common financial transaction activities conducted among the customers;
for each service of the services offered by the entity:
estimating a cost of recommendation of the service; and
estimating, for each of the customers in a corresponding group, a transaction risk of providing the service, the transaction risk estimated based on the common financial transaction activities; and
for each group in the groups of customers:
identifying services available that are not rendered for corresponding customers;
estimating, based on economic health data associated with the corresponding customers, a probability of an acceptance by the corresponding customers of an offer for available services;
estimating a profit based on historical profit data acquired from results of rendering the service to the corresponding customers of the respective group, the profit data derived from the common financial transaction activities; and
selecting, via the computer processor, at least a subset of the available services to offer the corresponding customers as a function of the cost of recommendation, the transaction risk, the probability of acceptance, and estimated profit.

2. The method of claim 1, wherein the cost of recommendation includes fees corresponding to advertising the service and a value item offered for service consideration.

3. The method of claim 1, wherein the estimating a transaction risk of providing the service includes performing a collective loss evaluation for customers in the corresponding group who have received the service.

4. The method of claim 1, wherein the identifying services available that are not rendered for the corresponding customers includes filtering each of the corresponding customers in the group according to the services provided and determining which services are not in a list resulting from the filtering.

5. The method of claim 1, wherein the classifying the customers further includes classifying the customers according to economic health data associated with the customers, the economic health data including at least one of:
customer account balance;
customer available credit;
customer ownership of assets; and
customer length of employment.

6. The method of claim 1, wherein the estimating a profit includes performing a collective profit evaluation for customers in the corresponding group who have received the service.

7. The method of claim 1, wherein the selecting at least a subset of the available services to offer the corresponding customers includes, for each customer of the customers in the group:
calculating a recommendation indicator value for each of the available services based on the cost of recommendation, the transaction risk, the probability of acceptance, and the estimated profit; and
offering the service to the customer when the recommendation indicator value meets or exceeds a predefined threshold.

8. The method of claim 1, wherein:
the predefined characteristics include at least one of:
customer type including business and consumer;
customer geographic location;
number of employees;
length of employment;
industry of customer business; and
customer age; and
the financial transaction activities include:
deposits to accounts;
withdrawals from accounts;
credit purchases;
cash purchases;
loans; and
investments.

9. The method of claim 1, wherein the services includes at least one of:
a credit account having terms defined based on the score; and
a savings account having terms defined based on the score.

10.-16. (canceled)

17. A computer program product comprising a storage medium embodied with machine-readable program instructions, which when executed by a computer, causes the computer to implement a method, the method comprising:
classifying customers of an entity into groups based on commonly shared, predefined characteristics and common financial transaction activities conducted among the customers;
for each service of the services offered by the entity:
estimating a cost of recommendation of the service; and
estimating, for each of the customers in a corresponding group, a transaction risk of providing the service, the transaction risk estimated based on the common financial transaction activities; and
for each group in the groups of customers:
identifying services available that are not rendered for corresponding customers;
estimating, based on economic health data associated with the corresponding customers, a probability of an acceptance by the corresponding customers of an offer for available services;
estimating a profit based on historical profit data acquired from results of rendering the service to the corresponding customers of the respective group, the profit data derived from the common financial transaction activities; and
selecting at least a subset of the available services to offer the corresponding customers as a function of the cost of recommendation, the transaction risk, the probability of acceptance, and estimated profit.

18. The computer program product of claim 17, wherein the cost of recommendation includes fees corresponding to advertising the service and providing a value item for service consideration.

19. The computer program product of claim 17, wherein the estimating a transaction risk of providing the service includes performing a collective loss evaluation for customers in the corresponding group who have received the service.

20. The computer program product of claim 17, wherein the identifying services available that are not rendered for the corresponding customers includes filtering each of the corresponding customers in the group according to the services provided and determining which services are not in a list resulting from the filtering.
